(19) United States
(12) Patent Application Publication
(10) Pub. No.: US 2007/0253027 A1
(43) Pub. Date: Nov. 1, 2007

(54) System and method for on-press merging of variable data printing documents

(76) Inventor: Steven P. Hiebert, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/412,258

(22) Filed: Apr. 27, 2006

(51) Int. Cl. G06K 15/00

(52) U.S. Cl. 358/1.18

(57) ABSTRACT

A digital printing press system for variable data printing (VDP) includes a front end and a press. The front end processes a static template and transmits the processed static template to the press. The press merges variable data processed subsequently by the front end with the static template to produce a desired stream of customized documents. A method of operating a digital printing press system for variable data printing (VDP) includes processing a static template with a front end of the press system; transmitting the processed static template to a press of the press system; and, on the press, merging variable data processed subsequently by the front end with the static template to produce a desired stream of customized documents.

### BACKGROUND

Since the early nineties, a growing sector of the global commercial printing industry has used digital, as opposed to lithographic offset, printing. With digital commercial printing, the images are created directly from electronic document data without requiring the time and expense needed to prepare traditional printing plates.

The digital document data is read from an electronic file and used to form printed images. Typically, the digital image data is rasterized by a Raster Image Processing (“RIP”) engine to convert the digital image data into a format that can be used by the digital press to produce a printed image. The rasterized data is then transferred to the imager or print engine of the digital press. Some commercial printing presses use small color particles suspended in imaging oil that can be attracted or repelled by means of a voltage differential. The rasterized image data is used to create appropriate voltage differentials corresponding to the image to be printed. The image is then printed directly onto a desired medium such as paper, cardstock, etc.

By its nature, digital printing is particularly useful for smaller to medium print job runs in both color and monochromatic formats. Digital printing is also typically favored when a fast turnaround is required because digital printing products require less drying time than print products prepared with traditional ink.

Digital printing also facilitates personalization or customization of the printed product. Because the image is reproduced each time from digital data, variations can be easily introduced. This allows the press to print short-run, on-demand and personalized jobs at full speed with virtually no preparation time.

In Variable Data Printing (“VDP”), some specific elements of the document being printed, such as text or pictures, are changed from one print to the next. Consequently, with VDP, a marketing or advertising campaign or other print job can include printed documents specifically targeted to, or printed for, any number of individuals or specific situations.

In any commercial digital printing, keeping the press working at full speed is highly desirable to maximize production and, therefore, profitability. Consequently, multiple Raster Image Processing (“RIP”) engines are often used to avoid any wasted time at the imager or print engine. For example, multiple RIP engines may be used to avoid wasting turns of an imaging drum of image or print engine. However, these RIP engines are expensive. Thus, addition multiple RIP engines increases the cost of the digital press.

Additionally, communication between a Digital Front End (“DFE”) and the press can be another bottleneck. The DFE is the unit that typically includes the RIP engines and rasterizes image data before sending the data to the imager or print engine of the digital press. Consequently, expensive network hardware may be needed to keep the data flowing from the DFE to the press at an appropriately high speed. This, too, adds significant expense to a digital press system.

These problems may be exacerbated in VDP where data is being changed or new data is being inserted into each image printed.

### SUMMARY

A digital printing press system for variable data printing (VDP) includes a front end and a press. The front end processes a static template and transmits the processed static template to the press. The press merges variable data processed subsequently by the front end with the static template to produce a desired stream of customized documents. A method of operating a digital printing press system for variable data printing (VDP) includes processing a static template with a front end of the press system; transmitting the processed static template to a press of the press system; and, on the press, merging variable data processed subsequently by the front end with the static template to produce a desired stream of customized documents.

### BRIEF DESCRIPTION OF THE DRAWINGS

The accompanying drawings illustrate various embodiments of the present invention and are a part of the specification. The illustrated embodiments are merely examples of the present invention and do not limit the scope of the claims.

FIG. 1 illustrates the various documents and templates used in a VDP system according to principles described herein.

FIG. 2 illustrates a method of operating a digital press system according to principles described herein.

FIG. 3 illustrates in a block diagram an example of a digital press system according to principles described herein.

Throughout the drawings, identical reference numbers designate similar, but not necessarily identical, elements.

### DETAILED DESCRIPTION

A digital press system as described herein typically includes a Digital Front End (“DFE”) and a press. In general, the Digital Front End prepares the digital image data for use by the press and then transmits the data to the press where the actual printed product is produced using the digital image data. As described above, the DFE typically rasterizes the digital image data to prepare the data for use by the digital press.

The present specification describes a system and method for Variable Data Printing in which the variable portions of the document are merged on the digital press with a previously-rasterized template containing the static portions of the document. As a result, the Digital Front End is required to rasterize and transmit a much lower volume of data to the press, thereby minimizing the demands on the Digital Front End and the connections between the Digital Front End and the press while still maximizing the productivity of the digital press.

As used herein and in the appended claims, the term digital commercial printing will refer to printing conducted on a commercial scale as opposed to digital printing performed with a personal computer and a connected or networked digital printer. As used herein and in the appended claims, Variable Data Printing (“VDP”) will refer to a print job in which a document is printed repeatedly, where the document includes static portions that remain the same from print to print and variable portions that are changed from print to print. The variable portions can be changed to customize or personalize each print of the document.

In the past, Variable Data Printing has been performed by merging a database with a template at the source level. The database contains all the data for the variable portions of the document. Thus, the variable data for each document is pulled from the database and added to the appropriate portions of a template which contains the static portions of the document. Consequently, a number of separate individual electronic documents is created, each containing both the static template and one set of the variable data from the database. The number of such documents created will correspond to the number of sets of variable data in the database.

This merge occurs at what is known as the source level, meaning that the documents produced are in a natural input format, such as Personalized Print Markup Language (PPML) or Portable Document Format (PDF). The template may be stored in the same natural input format prior to the merger. The variable data may also be stored in the database in the same natural input format prior to the merger or may be converted into the natural input format as part of the merger process.

The resulting stream of documents, each containing both the static template and a set of variable data, is then processed by one or more Raster Image Processing (“RIP”) engines. As described above, multiple RIP engines may be needed to produce rasterized image data at or above the rate that such data is used by the imager of the press. After each individual instance of the document is rasterized or “RIPed,” it must then be transmitted to the digital press. The digital press receives the series of documents and prints each to produce the desired hardcopies, each including both static and variable elements.

As noted above, this system may present difficulties as the DFE attempts to keep up with the imager of the digital press. The potential bottlenecks have traditionally been dealt with by: (1) using multiple RIP engines to rasterize the VDP documents in parallel so as to decrease the time required to rasterize all the documents in the batch, and (2) using expensive network hardware between the DFE and the press to maximize the transfer rate of date from the DFE to the imager of the press.

The present specification instead splits the task of VDP between the DFE and the press to avoid the potential bottlenecks that have occurred in previous systems. As described herein, a VDP static template document is processed and rasterized by the DFE without any variable data included and then sent to the press for storage as reusable data. The DFE then only need rasterize the variable data portion of the desired documents during the print run and transfer the rasterized variable data documents to the press for merger with the static template and printing.

As used herein and in the appended claims, the term “static template” will refer to a VDP template that contains the data which does not change, or is static, from print to print. In the static template, the portions or fields that are reserved for variable data may be left blank. As used herein and in the appended claims, the term “variable template” will refer to a template that corresponds to, and is subordinate to, the static template. In the variable template, the areas that correspond to the static content of the static template are left blank, while the areas that are to contain the variable data are so designated.

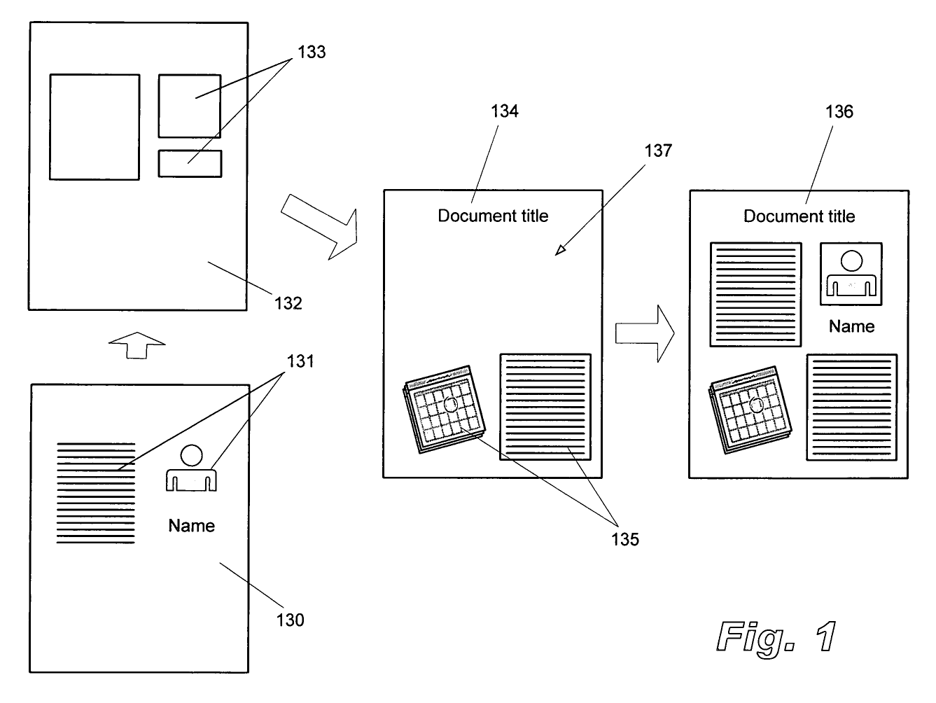

The relationship among these various documents and document templates is illustrated in FIG. 1. As shown in FIG. 1, the static template (134) includes the static elements (135) that remain the same from print to print. The static elements (135) can be any document elements, including, but not limited to, text, pictures, graphics, titles, headers, etc. The static template (134) is blank in those areas (e.g., 137) where variable data is to be inserted.

In contrast, the variable template (132) is blank in those areas that correspond to the static elements (135) of the static template (134). The variable template (132) has fields or areas (133) that are designated for the placement of variable data. In general, these fields (133) are located in areas corresponding to the blank portions (137) of the static template. However, in some embodiments, it may be the case that variable data is to be overlaid or superimposed, partially or completely, with static elements in the static template (134), in which case, the field (133) of the variable template (132) would overlap, partially or completely, with a static element (135) in the static template (137).

To produce a desired VDP document (136), a set of variable data (130) is taken from a database. The set of variable data (130) includes print elements (131) that are to vary from print to print. The variable print elements (131) may be any document elements, including, but not limited to, text, pictures, graphics, titles, headers, etc. The variable data (130) is used to populate the fields (133) of the variable template (132). As described below, the populated variable template is then rasterized and sent to the digital press.

On the digital press, the rasterized variable template is merged with the static template (134) and then printed as a completed VDP document (136). With each document printed, a new variable template, populated with different variable data, is received and merged with the static template to produce a customized VDP document (136).

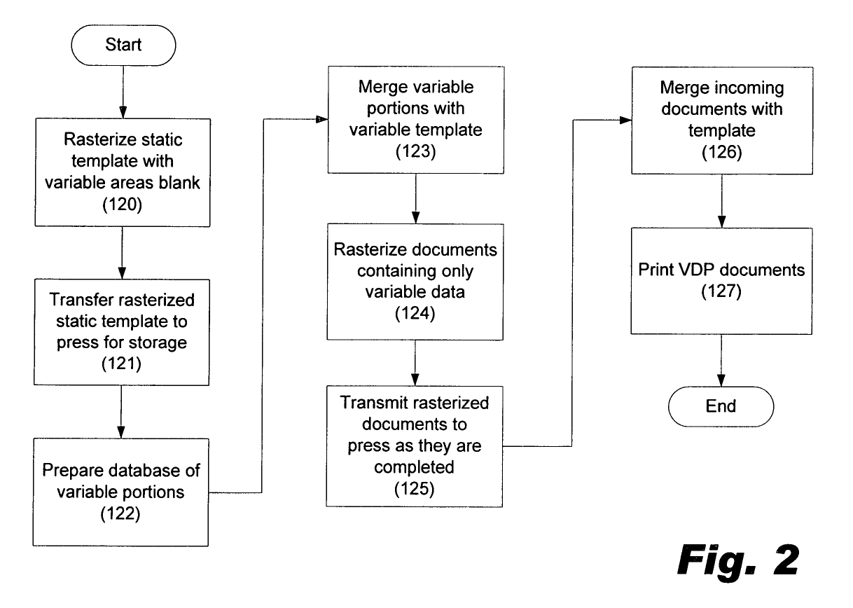

This process is further illustrated in FIG. 2. As will be appreciated by those of skill in the art, the steps of FIG. 2 may be modified or reordered as best suits a particular application. As shown in FIG. 2, the static template is supplied to the DFE. The static template may be supplied to the DFE in its natural input format, e.g., PPML or PDF. As described above, all areas that will contain variable data are generally left blank. The static template is then rasterized (step 120) by the DFE and transmitted in rasterized form to the digital press (step 121). The system is then ready for a VDP run.

A database is also prepared (step 122) that contains the variable portions of the VDP documents to be produced. The database can be prepared before, during or after the preparation and rasterization of the static template.

Once the database of variable data has been prepared and is available to the DFE, the print run can begin. The DFE will access each set of variable data and merge that variable data with the variable template (step 123). This produces a stream of documents, each being a copy of the variable template populated with a different set of variable data. As noted above, the portions of these documents corresponding to the static elements of the static template are generally blank.

The documents are then rasterized (step 124) by the DFE. Because a significant portion of the documents are blank, corresponding to the static elements of the static template, the demands on the RIP engine(s) are minimized. Essentially, only the variable elements for each VDP document need be rasterized during the print run.

The rasterized documents are then transferred to the digital press (step 125). Each document may be transmitted as it is rasterized.

The press receives the rasterized documents, each being a copy of the variable template populated with a different set of variable data, and merges each such document with the static template (step 126). Additional details about the merger of the incoming documents with the previously-rasterized static template will be given below.

The ongoing merger of the incoming documents with the static template produces a new stream of VDP documents, each containing the static elements of the static template and a set of variable elements. The documents are then printed (step 127) by the digital press. The result is a print run of VDP documents each of which is customized by the variable data while containing static elements that do not vary from document to document.

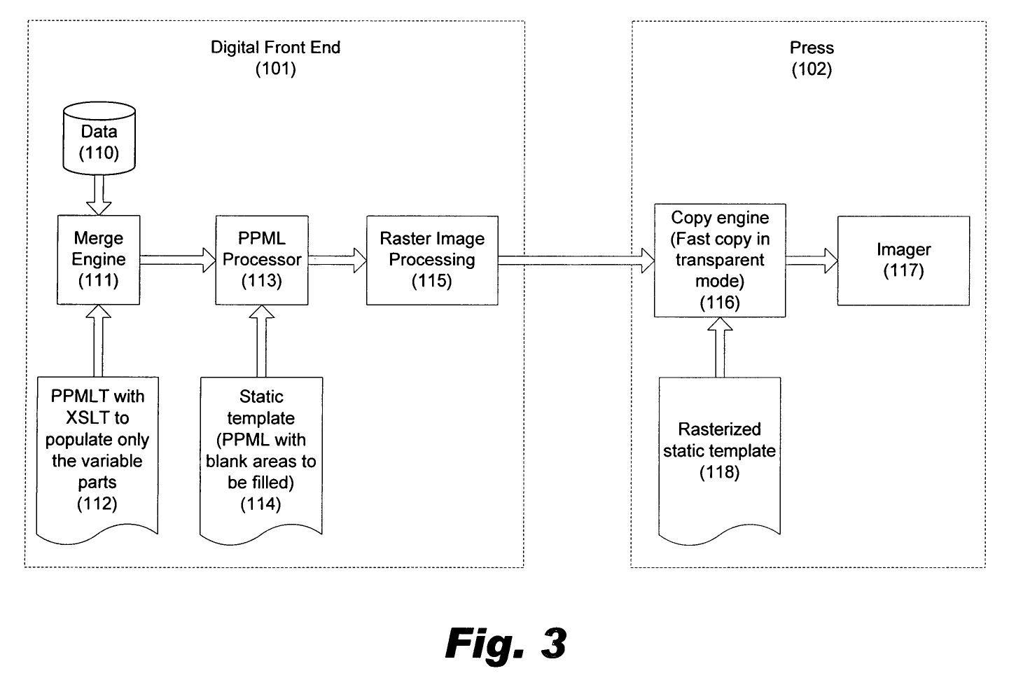

FIG. 3 illustrates in a block diagram an example of a digital press system according to principles described herein. The press system illustrated in FIG. 3 can be operated according to the method illustrated in FIG. 2, for example.

As shown in FIG. 3, the digital press system includes the digital front end (“DFE”) (101) and the digital press (102). As described above, the digital press (102) includes an imager (117), also referred to as a digital print engine. The imager (117) is the hardware that actually produces a printed hardcopy of the desired digital image on a print medium, such as paper or other print stock. The digital press (102) also stores in memory a rasterized version of the static template (118) for the VDP run.

The static template (114), absent the variable portions, is prepared by the DFE (101) and is then transmitted to and stored on the press (102). In the example of FIG. 3, the static template (114) is a PPML document with blank areas corresponding to the poritions of the document that are to vary from print to print. The static template (114) is processed by the DFE (101) through a PPML processor (113) and a Raster Image Processing engine (115). The result is a rasterized static template (118) that is transmitted to and stored on the digital press (102).

Consequently, as explained above, only the variable portions of the document need be processed and rasterized by the DFE (101) and transferred to the press (102) during a print run. The press (102) then merges the incoming variable data with the rasterized static template (118) to produce the desired series of customized VDP documents.

As described above, the variable portions of the VDP documents are prepared and stored in a database (110) which is accessible to the DFE (101). The variable portions of the VDP documents may be created using existing database merge technologies such as the PPML Templating Language (“PPMLT”) and a PPMLT template. In the example of FIG. 3, the PPMLT template (112) serves as the variable template described above.

The PPMLT template element (112) contains only those areas of the static template (114) that were meant to be variable. Instructions for populating those areas from the database (110) may be provided, for example, by appropriate Extensible Stylesheet Language Transformations (“XSLT”).

Referring to FIG. 3, a merge engine (111) will populate a copy of the PPMLT template (112) with each set of variable data taken from the database (110). The resulting stream of PPML documents are blank in all areas except those where the variable elements have been inserted.

This stream of PPML documents is then processed through the PPML processor (113) and rasterized by the Raster Image Processing (“RIP”) engine (115). In FIG. 3, only a single RIP engine is shown. However, any number of RIP engines may be included as needed to keep pace with the press. Because the DFE (101) only needs to rasterize the variable data of the VDP run, a single RIP engine (115) may be sufficient.

The rasterized VDP documents are then transferred to the press (102) as described above. The press (102) then merges the PPML documents with the static template (118). This may be done, for example, by the press (102) simply copying each variable PPML document onto the stored static template (118) using a transparent mode such that only those areas with content in the variable PPML document overwrite the template (118). This operation is performed by a copy engine (116) of the press (102). The resulting document is then ready for printing using the normal press print path.

By storing a previously rasterized template document on the press, communication time between the DFE and the press is minimized. The process of rasterizing the variable PPML documents is decreased due to the large amount of non-varying data in each document that is represented by the static template (118) and that does not have to be re-rasterized with each document as in previous systems. Additionally, because the PPML documents contain only the varying data, the rasterized PPML documents can be significantly compressed further improving communication speed between the DFE (101) and the press (102). Also, since merging the database with the stripped down variable template is done in the DFE (101), different merge technologies can be employed without affecting the press software.

The principles described herein may be implemented, for example, in an Indigo Digital Printing Press by Hewlett-Packard Co.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A digital printing press system for variable data printing (VDP) comprising:
a front end; and
a press;
wherein said front end processes a static template and transmits the processed static template to said press; and
wherein said press merges variable data processed subsequently by said front end with said static template to produce a desired stream of customized documents.

2. The system of claim 1, wherein said front end comprises a Raster Image Processing Engine for rasterizing said static template before transmitting said static template to said press.

3. The system of claim 1, wherein said front end comprises:
a database containing a plurality of sets of said variable data; and
a merge engine for merging said variable data with a variable template.

4. The system of claim, 3, further comprising a Personalized Print Markup Language (PPML) processor for processing copies of said variable template populated with said variable data.

5. The system of claim 3, further comprising a Raster Image Processing Engine for rasterizing copies of said variable template populated with said variable data.

6. The system of claim 3, wherein said press further comprises a copy engine for copying each copy of said variable template populated with variable data onto said static template using a transparent mode such that only those areas with content in the populated variable template overwrite the static template.

7. The system of claim 3, wherein said variable template comprises instructions for populating said variable template with said variable data.

8. The system of claim 7, wherein said instructions are Extensible Stylesheet Language Transformations (“XSLT”).

9. A method of operating a digital printing press system for variable data printing (VDP) comprising:
processing a static template with a front end of said press system;
transmitting the processed static template to a press of said press system; and
on said press, merging variable data processed subsequently by said front end with said static template to produce a desired stream of customized documents.

10. The method of claim 9, wherein said processing comprises rasterizing said static template with a Raster Image Processing Engine of said front end.

11. The method of claim 9, further comprising, on said front end, merging sets of variable data from a database with copies of a variable template.

12. The method of claim, 11, further comprising processing said copies of said variable template populated with said variable data with a Personalized Print Markup Language (PPML) processor.

13. The method of claim 11, further comprising rasterizing copies of said variable template populated with said variable data with a Raster Image Processing Engine.

14. The method of claim 11, further comprising, on said press, copying each copy of said variable template populated with variable data onto said static template using a transparent mode such that only those areas with content in the populated variable template overwrite the static template.

15. The method of claim 11, wherein said variable template comprises instructions for populating said variable template with said variable data.

16. The method of claim 15, wherein said instructions are Extensible Stylesheet Language Transformations (“XSLT”).

17. The method of claim 9, further comprising printing said stream of customized documents with said press.

18. A digital printing press system for variable data printing (VDP) comprising:
means for processing a static template with a front end of said press system and transmitting the processed static template to a press of said press system; and
means, on said press, for merging variable data processed subsequently by said front end with said static template to produce a desired stream of customized documents.

19. The system of claim 18, further comprising, on said front end, means for merging sets of variable data from a database with copies of a variable template.

20. The system of claim 19, further comprising, on said press, means for copying each copy of said variable template populated with variable data onto said static template using a transparent mode such that only those areas with content in the populated variable template overwrite the static template.
